(19) United States
(12) Patent Application Publication
(10) Pub. No.: US 2011/0218467 A1
(43) Pub. Date: Sep. 8, 2011

(54) PORTABLE CARDIOPULMONARY RESUSCITATOR FOR IMPLEMENTING CARDIOPULMONARY RESUSCITATION

(76) Inventor: Chin-Fu HSU, Yonghe City (TW)

(21) Appl. No.: 12/716,944

(22) Filed: Mar. 3, 2010

(51) Int. Cl. A61H 31/00

(52) U.S. Cl. 601/41

(57) ABSTRACT

A portable cardiopulmonary resuscitator for implementing CPR to rescue a user includes a pressing mechanism and a respiration aid. The pressing mechanism includes a pressing element and a pumping element. The pressing element is pressed to massage a heart of the user and the pumping element is operated to produce and discharge air. The respiration aid includes a tube and a mask, an end of the tube is extended from the pumping element and the other end of the tube is provided with the mask which is covered on a face of the user. By the aforementioned structures, a rescuer can use the present invention to perform the CPR to a patient, with infection of germs by being in contact with saliva being avoided, which is indeed provided with practical progressiveness.

### BACKGROUND OF THE INVENTION

a) Field of the Invention

The present invention relates to a cardiopulmonary resuscitator and more particularly to a portable cardiopulmonary resuscitator for implementing CPR (Cardiopulmonary Resuscitation) which can be used to press at a heart location of a patient and blow air into a lung of the patient without a mouth and nose of a rescuer touching the patient.

b) Description of the Prior Art

When a patient stops breathing or his or her heart stops beating, CPR should be implemented quickly; otherwise, after the patient has stopped breathing and the heart has stopped beating, as blood cannot circulate, oxygen will not be able to be delivered to all organs in the body, which may cause necrosis to all the organs in the body, especially a brain. According to research, if the brain is in short of oxygen for over four minutes, it may cause the necrosis to the brain cells. In addition, the extent of damage is dependent upon the time without oxygen and if the time without oxygen exceeds ten minutes, then it is possible to cause an unrecoverable damage or even brain death to the brain.

As a result, after the patient has stopped breathing and the heart beat has ceased, it will be very important to implement the CPR quickly and accurately; and timely carrying out the CPR to the patient is a preliminary and essential emergency care item to restore respiration and heart beat of the patient.

Usually, a rescuer has to clear a respiratory tract of the patient first. Next, a heart massage and artificial respiration are implemented, so as to stimulate the heart and lung of the patient to restore the heart beat and respiration, thereby saving the life of patient timely.

However, upon using the aforementioned CPR, following issues and shortcomings actually exist to be improved.

When the rescuer is performing mouth-to-mouth artificial respiration to the patient, mouth-to-mouth contact between the rescuer and the patient is inevitable. Nevertheless, the rescuer may be infected by all kinds of germs by being in contact with saliva of the patient or may even feel not hygienical by touching vomitus of the patient. Therefore, a non-professional cannot often conduct rescuing quickly and accurately when rescuing the patient and thus it indeed requires improvement.

### SUMMARY OF THE INVENTION

The primary object of the present invention is to provide a cardiopulmonary resuscitator allowing a rescuer not to directly touch a patient.

To achieve the aforementioned object, the present invention includes a pressing mechanism and a respiration aid. The pressing mechanism includes a pressing element and a pumping element, wherein the pressing element can be pressed to massage a heart of the patient and the pumping element can be operated to produce and discharge air. The respiration aid, on the other hand, includes a tube and a mask; an end of the tube is extended from the pumping element and the other end of the tube is provided with the mask which can be covered on a face of the patient.

As the present invention includes the pressing mechanism containing the pressing element and the pumping element, when the rescuer is to conduct CPR to the patient, the rescuer only needs to align the pressing element at a heart location of the patient and then to exert force to the pressing element that the rescuer can massage the heart of the patient to stimulate the heart of the patient, allowing the heart to restore normal beating. On the other hand, after massaging the heart for a certain number of times, the pumping element is then operated to produce and discharge air to the tube of the respiration aid, thereby allowing air to be blown into a mouth of the patient. By the aforementioned structures, when the rescuer is implementing the CPR to the patient, a mouth and nose of the rescuer will not touch the patient, so as to prevent from infection with germs caused by touching saliva of the patient. Furthermore, the present invention is assembled easily, which is indeed an invention of good performance and progressiveness.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of a preferred embodiment of the present invention.

FIG. 2 shows a three-dimensional exploded view of the preferred embodiment of the present invention.

FIG. 3 shows a first schematic view of an implementation of the preferred embodiment of the present invention.

FIG. 4 shows a second schematic view of the implementation of the preferred embodiment of the present invention.

FIG. 5 shows a third schematic view of the implementation of the preferred embodiment of the present invention.

FIG. 6 shows a first schematic view of an implementation of another preferred embodiment of the present invention.

FIG. 7 shows a second schematic view of the implementation of another preferred embodiment of the present invention.

FIG. 8 shows a third schematic view of the implementation of another preferred embodiment of the present invention.

### DETAILED DESCRIPTION OF THE PREFERRED EMBODIMENTS

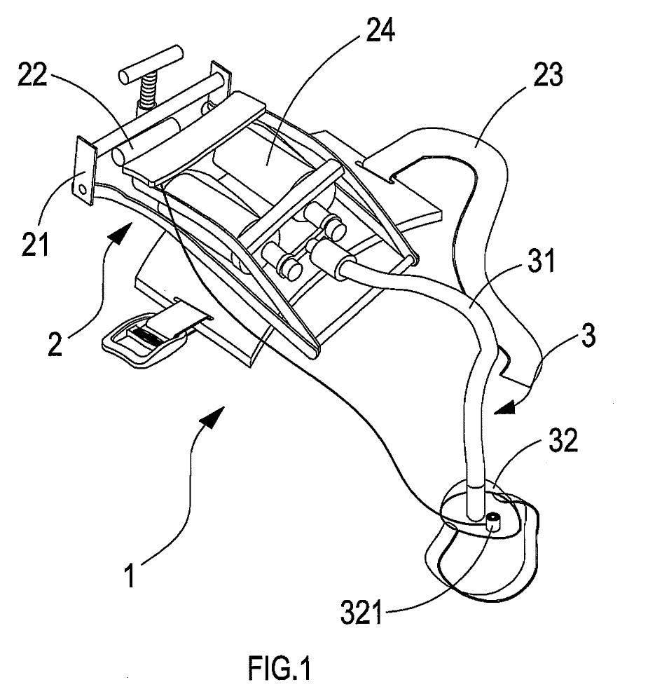

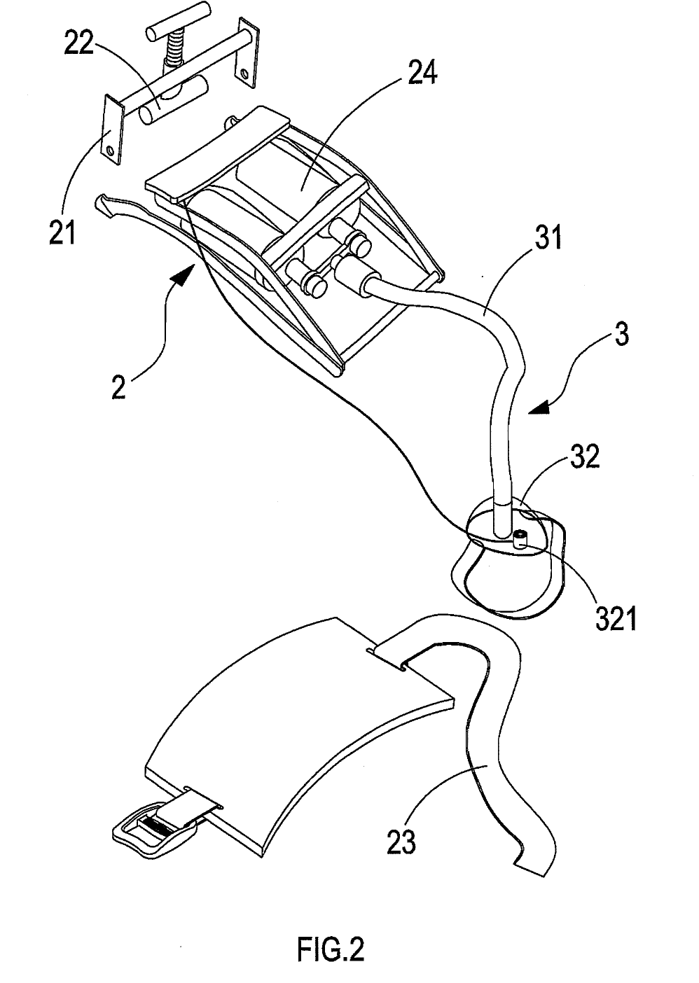

Referring to FIG. 1 and FIG. 2, it shows a three-dimensional schematic view and a three-dimensional exploded view, of a preferred embodiment of the present invention. As shown in the drawings, a cardiopulmonary resuscitator 1 of the present invention comprises:

a pressing mechanism 2 which includes a bracket 21, a pressing element 22 and a pumping element 24, with the pressing element 22 and the pumping element 24 being provided on the bracket 21, the pressing element 22 being pressed to massage a heart of a user, the pumping element 24 being operated to produce and discharge air and the pressing mechanism 2 being assembled with a binding mechanism 23 which is a belt; and

a respiration aid 3 which includes a tube 31 and a mask 32, with an end of the tube 31 being extended from the pumping element 24 and the other end of the tube 31 being provided with the mask 32 on which is installed with an air valve 321.

Besides, the cardiopulmonary resuscitator 1 can be further connected with a pulsimeter or a defibrillator.

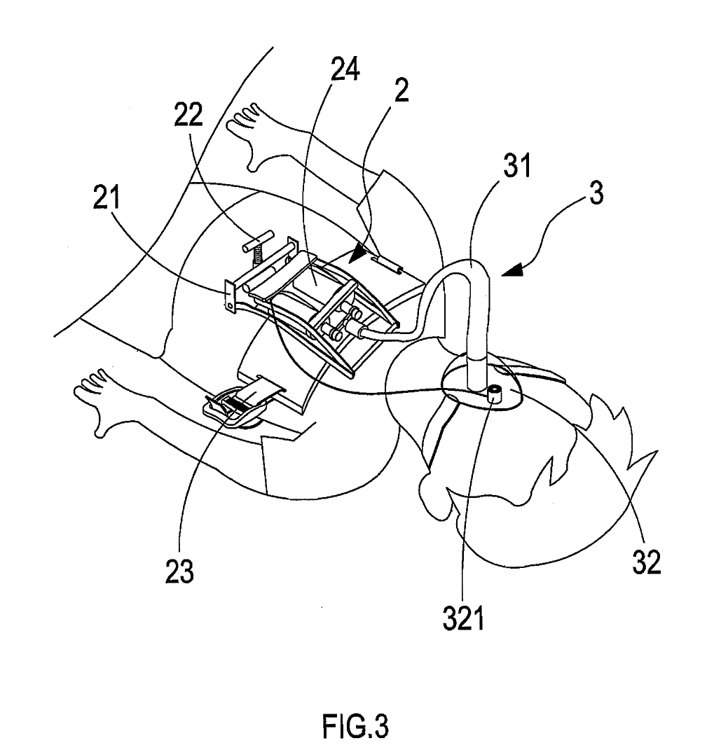

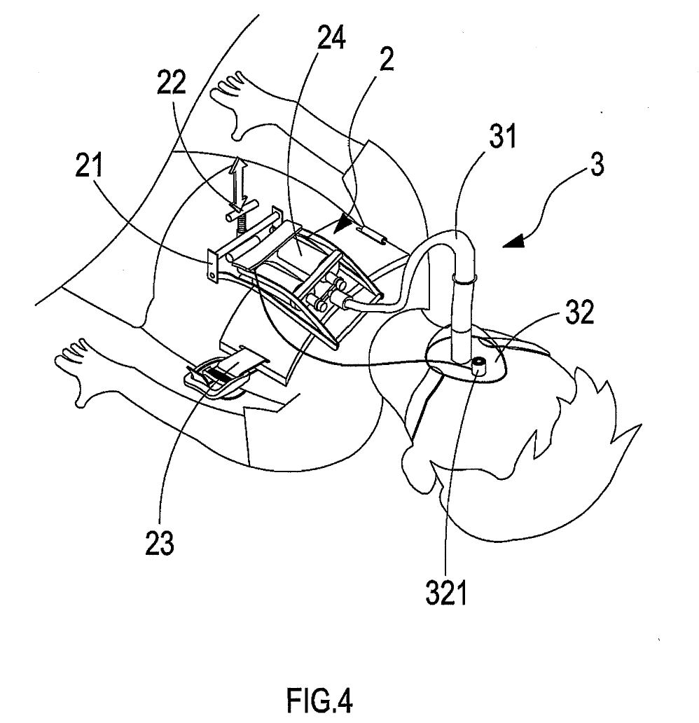

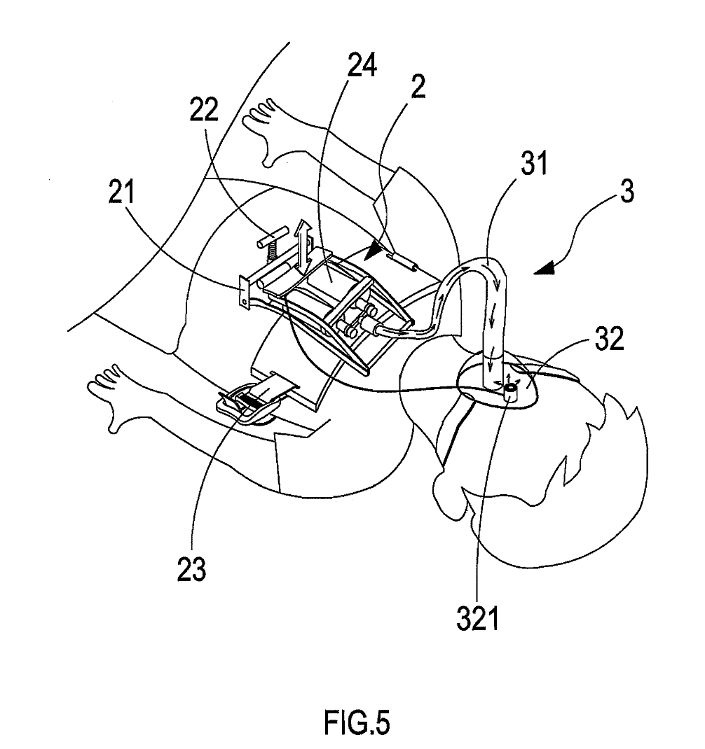

Referring to FIGS. 2 to 5, it shows the three-dimensional exploded view, a first schematic view of an implementation, a second schematic view of the implementation and a third schematic view of the implementation, of the preferred embodiment of the present invention. As shown in the drawings, when a patient needs CPR, the pressing mechanism 2 can be aligned and emplaced onto a heart position of the patient; whereas, the pressing mechanism 2 is provided with the binding mechanism 23 which is the belt. A rescuer can first utilize the belt to effectively fix the pressing mechanism 2 on a chest of the patient to avoid movement of the pressing mechanism 2. As a result, installation of the pressing mechanism 2 is accomplished. Next, the mask 32 of the respiration aid 3 is covered on a mouth of the patient, where a rubber band can be used to fix the mask 32 on the mouth of the patient. Therefore, installation of the respiration aid 3 is accomplished as well.

After installing the pressing mechanism 2 and the respiration aid 3, the rescuer can utilize the present invention to proceed with the CPR. As the pressing mechanism 2 of the present invention includes the pressing element 22, the rescuer only needs to press the pressing element 22 against the heart position of the patient that the rescuer can massage the heart of the patient to stimulate the heart of the patient, allowing the heart of the patient to beat spontaneously. In addition, when carrying out a certain number of times of heart massaging, the rescuer can operate the pumping element 24 to blow air into a mouth of the patient, thereby stimulating a lung of the patient that the patient can breathe spontaneously again. The pumping can be performed by manual compression, electricity, an air bag or air blowing, wherein, either the manual or electrical pumping is feasible in the present invention. As the mask 32 is covered on the mouth of the patient, air can enter into the lung of the patient to stimulate the patient to breathe spontaneously. Furthermore, as the mask 32 of the present invention is provided with the air valve 321, the rescuer can open the air valve 321 to release excessive waste gas of a human body. The air valve 321 can be connected with a rope such that when the rescuer presses down the pumping element 24, the air valve 321 is closed; on the other hand, when the pumping element 24 is released, the air valve 321 is opened to form an effect of breathing naturally. Accordingly, a mouth and nose of the rescuer will not touch the patient and the present invention can be easily assembled, which is actually provided with advancement.

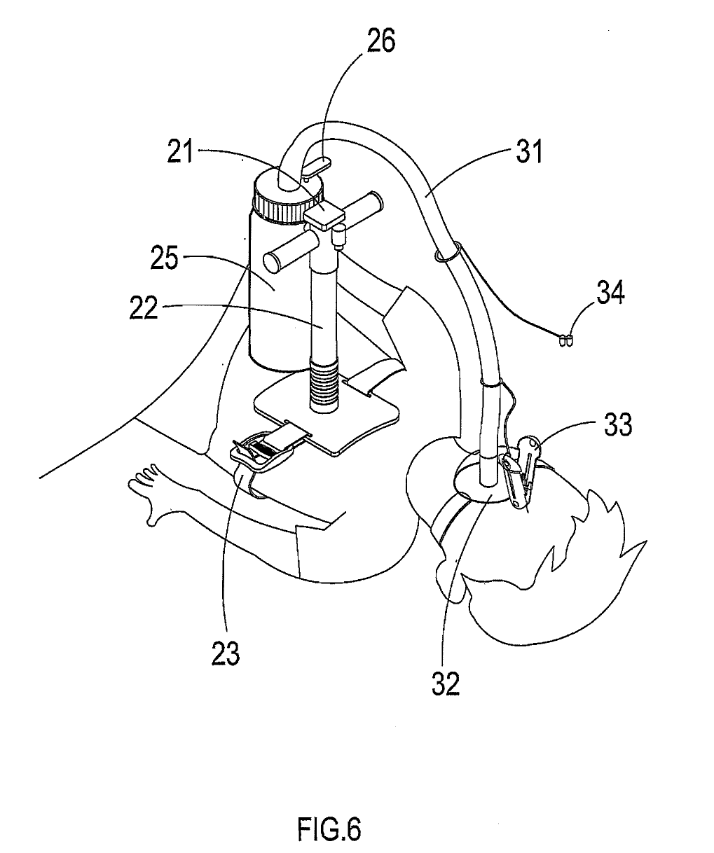

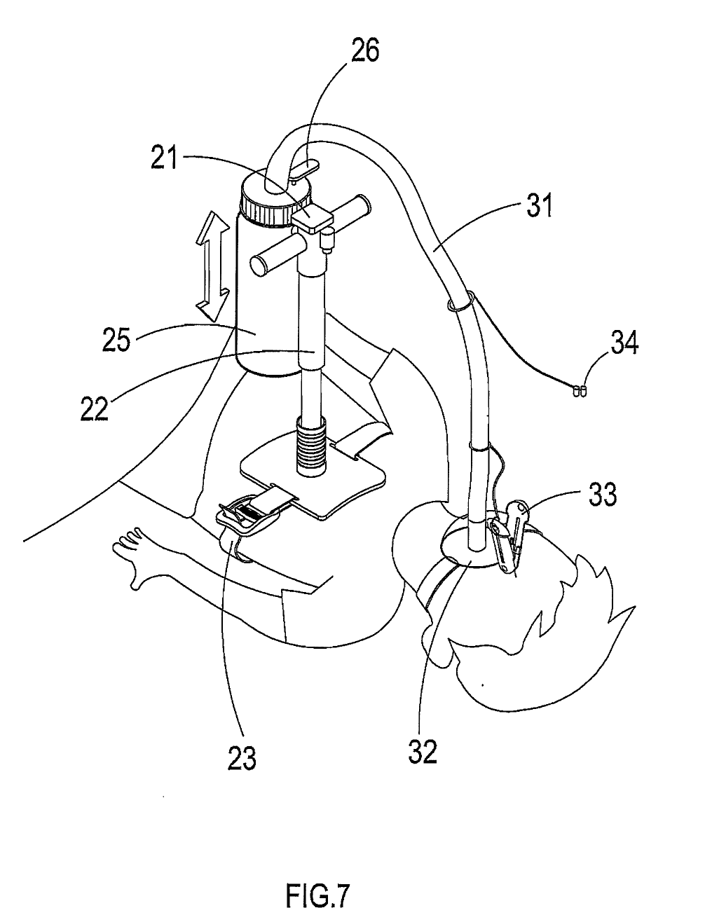

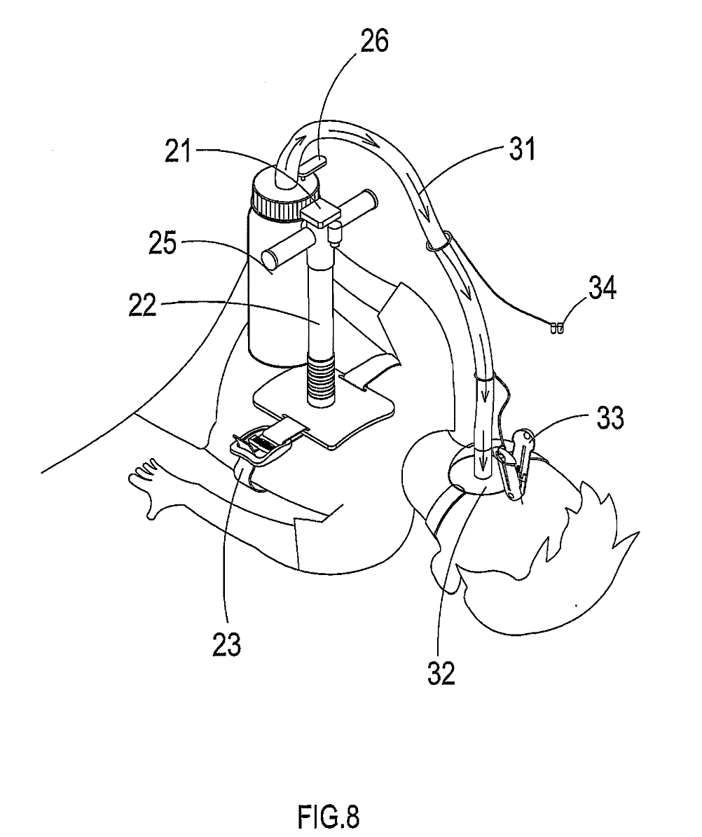

Referring to FIGS. 2, 6 to 8, it shows the three-dimensional exploded view of the preferred embodiment of the present invention, as well as a first to third schematic views of an implementation of another preferred embodiment of the present invention. As shown in the drawings, the pressing mechanism 2 of the present invention can be further provided with an air storage element 25 which is extended with the pressing element 22, such that when the pressing element 22 is pressed to conduct a piston movement, air can be stored in the air storage element 25. When the patient needs the CPR, the pressing mechanism 2 can be aligned and emplaced onto the heart position of the patient and the pressing mechanism 2 is provided with the binding mechanism 23 which is the belt. As a result, the rescuer can first utilize the belt to effectively fix the pressing mechanism 2 on the chest of the patient to avoid the movement of the pressing mechanism 2, thereby accomplishing the installation of the pressing mechanism 2. Next, the mask 32 of the respiration aid 3 is covered on the mouth of the patient where a rubber band can be used to fix the mask 32 at the mouth of the patient, thereby accomplishing the installation of the respiration aid 3 as well.

After installing the pressing mechanism 2 and the respiration aid 3, the rescuer can use the present invention to proceed with the CPR. As the pressing mechanism 2 of the present invention includes the pressing element 22 and when the pressing element 22 is pressed to conduct the piston movement, air can be stored in the air storage element 5, the rescuer only needs to press the pressing element 22 against the heart position of the patient that the rescuer can massage the heart of the patient to stimulate the heart of the patient, allowing the heart of the patient to beat spontaneously and air to be stored in the air storage element 25 at a same time. The air can be stored by manual compression, electricity, an air bag or air blowing. The pressing element 22 can be provided with a switch and when the switch is turned on, it can switch to the electric method to press the pressing element 22; whereas, either the manual or electrical method is feasible in the present invention. Besides, as there is a ventilation switch 26 between the tube 31 and the air storage element 25, when the ventilation switch 26 is turned on after carrying out the CPR for a predefined number of times, the air storage element 25 can discharge out the air stored. As the mask 32 is covered on the mouth of the patient, air can be discharged into the lung of the patient to stimulate the patient to breathe spontaneously. Therefore, the mouth and nose of the rescuer will not touch the patient and the present invention is assembled easily, which is actually provided with the advancement.

Furthermore, the tube 31 can be extended with a nose clip 33 and a nose plug 34 which can prevent from air leak when air is discharged into the lung of the patient.

Accordingly, referring to all the drawings, the present invention is indeed provided with following advantages in comparison with the prior art, upon use.

The present invention includes the pressing mechanism 2 and the respiration aid 3, such that when carrying out the CPR to the patient, the pressing element 22 can be used to massage the heart of the patient to stimulate the heart of the patient, allowing the heart to restore natural beating. Whereas, when performing a certain number of times of heart massaging, the pumping element 24 can be operated to produce and discharge air toward the tube 31 of the respiration aid 3 and air can be discharged into the lung of the patient through the mouth of the patient, thereby stimulating the lung of the patient to restore natural breathing. According to the aforementioned structures and operations, the mouth and nose of the rescuer will not touch the patient, which can prevent from infection of germs by being in contact with saliva of the patient. In addition, the present invention can be assembled conveniently and quickly, which is indeed provided with practical progressiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A portable cardiopulmonary resuscitator for implementing CPR (Cardiopulmonary Resuscitation) being used to rescue a predefined user, comprising:
a pressing mechanism which includes a pressing element and a pumping element, with the pressing element being pressed to massage a heart of the user and the pumping element being operated to produce and discharge air; and
a respiration aid which includes a tube and a mask, with an end of the tube being extended from the pumping element and the other end of the tube being provided with the mask to be covered on a face of the user.

2. The portable cardiopulmonary resuscitator for implementing CPR, according to claim 1, wherein the pressing mechanism is assembled with a binding mechanism.

3. The portable cardiopulmonary resuscitator for implementing CPR, according to claim 2, wherein the binding mechanism is a belt.

4. The portable cardiopulmonary resuscitator for implementing CPR, according to claim 1, wherein the pressing mechanism further includes a bracket on which is provided with the pressing element and the pumping element.

5. The portable cardiopulmonary resuscitator for implementing CPR, according to claim 1, wherein the mask is provided with an air valve.

6. The portable cardiopulmonary resuscitator for implementing CPR, according to claim 1, wherein the cardiopulmonary resuscitator is further connected with a pulsimeter.

7. The portable cardiopulmonary resuscitator for implementing CPR, according to claim 1, wherein the cardiopulmonary resuscitator is further connected with a defibrillator.

8. The portable cardiopulmonary resuscitator for implementing CPR, according to claim 1, wherein the pressing mechanism further includes an air storage element which is extended with the pressing element, such that when the pressing element is pressed to conduct a piston movement, air is stored in the air storage element.

9. The portable cardiopulmonary resuscitator for implementing CPR, according to claim 8, wherein the pressing element stores air to the air storage element by manual compression, electricity, an air bag or air blowing.
